(19) United States
(12) Patent Application Publication
(10) Pub. No.: US 2019/0021300 A1
(43) Pub. Date: Jan. 24, 2019

(54) Lifelike soft fishing lure system and method of manufacturing

(71) Applicants: Chad Steven Smith, Battle Lake, MN (US); Lloyd Kenneth Willard, Miltona, MN (US); Jesse S. Maland, Alexandria, MN (US)

(72) Inventors: Chad Steven Smith, Battle Lake, MN (US); Lloyd Kenneth Willard, Miltona, MN (US); Jesse S. Maland, Alexandria, MN (US)

(73) Assignee: WildTail Fishing, LLC., Bertha, MN (US)

(21) Appl. No.: 15/998,060

(22) Filed: Jun. 21, 2018

Related U.S. Application Data
(60) Provisional application No. 62/604,074, filed on Jun. 22, 2017.

(51) Int. Cl. A01K 85/08; B29C 45/14

(52) U.S. Cl. CPC A01K 85/08; B29K 2021/00; B29C 45/14688; B29C 45/14786

(57) ABSTRACT

A fishing lure component and system is provided for soft baits which is highly strain resistant and tear resistant in the major stress longitudinally while placid in the vertical axis. The component employs a textile comprised of synthetic or natural fibers of dimension and configuration to dissipate penetration damage from hooking, or fish biting over the adjacent fibers providing protection of stresses up to 100 times that of soft bait lures. Component allows for the forming and movement in use to replicate living bait creatures. System includes features for hook installation, 3 dimensional color appearance thru polymer, infinite variation coloration, over-molding, and coating.

### BACKGROUND OF INVENTION

Currently, there are families of fishing baits which are generally referred to as artificial bate. Non rigid or soft artificial bates are frequently (but not exclusively) formed from elastomeric products in order to attempt to imitate the flexibility of natural bates such as worms, frogs, minnows and other bait fish, crayfish etc.

Molding is generally used to produce artificial lures. Commonly artificial lures are made by the process of injection molding using soft polymeric material. For small scale operations and simple lure designs the process of pour molding is typically used. Lure features are normally very simple and coloring limited to one or two colors. The soft bait lures being produced today as state of the art have several performance shortcomings and configuration limitations that are improved upon markedly by the devices and methods described hereafter.

The first deficiency is that artificial baits are far too fragile in the small features to withstand the attack by the fish. The small features such as the legs or claws break off very easily, leaving the lure malformed. The bait then no longer duplicates the form or motion of the real life creature it is meant to imitate. The fish usually won't respond to baits that are damaged. The vulnerability to tearing of the features depends primarily upon the how thick the cross sections are. The solution of thickening up the cross sections of the extremities has been employed by manufacturers. This will reduce tearing to some degree, but there is usually a point where the further thickening eliminates the useful movement of the extremities. For this reason the design tradeoff is to accept fragile extremities that break off frequently. While the manufacturer is currently not penalized for this since nearly all soft lures share in this deficiency, the fisherman hates the frequent changing of tackle and the cost of these consumables.

Second, currently the hook retention is not acceptable. The hooks are installed into the artificial bait in a manner which is meant to restrict the lure from hooking weeds or other obstacles until they are “set” into the fish's mouth. When the bait is cast the lure is thrown rapidly, and when the fisherman attempts to set the hook, a hard and rapid jerking of the rod is used. This causes forces that are very high and the lure is often torn off the hook and lost, or damaged beyond usefulness. To be effective the hook position must remain stable in the lure. Current soft lures do not provide sufficient strength at the hook to lure interfaces. Additionally, unnecessary pollution is introduced from the lures littering the bottom of the lakes.

Third, the motions of the baits as they are pulled through the water are very limited. As mentioned above, the cross sectional areas affect the strength and the shape of the feature affects the motion. The designer currently has few options to achieve lifelike movements from a lure since rapid movements usually requires relatively thin flexible features that are strong along a plane; a combination not available

Fourth, live baits usually have complex coloration. Current state of the art lures are normally made by the process of molding. Most are made by injection molding. A small minority are made by pour molding. It is very difficult to introduce color variations into molded parts. Typically soft lures are molding in one color, occasionally two and vary rarely three, and these colors are limited to specific parts of the creature bait. The reason for this color limitation is that is the injection molding process to produce multiple colors requires that both the mold and the molding equipment be very complex and expensive. In order to produce multicolor bait an area within the mold is restricted with a protective baffle while the first area is filled. The baffle is then removed or retracted and the second area is filled with the second color. When properly accomplished the two segments bond together and there is a slight feathering of the color schemes at their points of union. Also, two or more colors can be combined in a shared gate to give a swirling look or split the bait with half of or a partial of each color. While this process is effective it does not allow for the flexibility of coloration that live baits such as frogs possess. This limitation does not allow for the production of life-like baits.

To remedy this limitation some manufacturers do paint the outside of the lure with air brushes. This is effective in introducing more interesting features which are more lifelike, but has the further limitation of being time consuming and costly. Painted lures typically do not display any form of translucence. If living baits such as minnows or frogs are examined in the light it is easy to observe features under the skin. The leg bones, or the lungs, or the skeleton can be observed. Underwater creatures are rarely solid in color or opaque. Light is an important tool for the fisherman. The competitive fishermen focus on creating the proper shades and changes of shades to the fish. On dark days, the fisherman will use different colors than on bright days. When fishing in shallows the fisherman will use different lure colors then in the depths. Creating the proper shades is important. As an example, when a lure is cast under into or under lily pads and drawn back toward the shore or dock it is often very desirable that the lure goes from a dark appearance to a bright one in order to catch the attention of the fish. For this reason, baits with more complex coloration increases this effect. Translucence dramatically increases this effect.

The coloring and shading capabilities of the current state of the art are very elementary today. Bait creatures are rarely close to realistic. Methods to increase the complexity of the coloration such as external paintings with an airbrush are expensive also introduce chemical paint products to the lure.

Fifth, bait materials are preferably bio-degradable. While this is not a universal practice today, it is likely that the industry will be forced to move this direction entirely in the near future by consumer and/or legislative action. It is already exceedingly difficult to establish homogenous elastomeric lures that are relatively soft or flexible and will not be that easily be torn apart. As materials are chosen which are biodegradable they often do not exhibit the same degree of strength in comparison to their flexibility. Generally, materials which break down rapidly also tear apart at lower stresses and strains. The prior points discussed become an even larger challenge to the designer when rapidly biodegrading materials are introduced.

Currently, there is no soft lure, or method of producing lures which address the shortcomings individually, or as a group which have previously been described. Therefore there is a need for soft bait lures that are strong and very flexible, versatile in color and translucency, and versatile in allowing for biodegradable molding materials.

### BRIEF SUMMARY OF INVENTION

The present invention is directed to a fishing lure system constructed of a textile structure capable of infinite coloration variations either used by itself or, but not limited to being coated with soft elastomers or over molded with soft or rigid polymers and methods of hook attachment and the method of manufacturing thereof.

Soft lures are a popular choice for fisherman and used in a variety of fishing applications. The baits are attached to the hook at the tip of the lure with either a spiral coil, a barb, or with an offset in the hook. The hook itself is placed through the lure body. One feature of this invention is the highly flexible, and strong textile body. This textile body can be configured in infinite shapes and sizes with one or more textile layers with hooking options fisherman are familiar with along with other hooking or hook attachment features disclosed. The textile configuration is chosen which provides the necessary desired strength in the directions which the load will be applied, and the flexibility to bending which is also desired for action of lure itself and throughout its appendages. The textile body has superior hook retention capability that significantly decreases the loss of lure off hook and need to re-hook or adjust lure body on hook keeping the lure in the water longer. In addition to the benefit of greater hook retention the textile lure will hold up much longer than a traditional soft plastic lures.

Another feature to the textile lure is that the textile fibers can be hardened or formed by but not limited to heat or pressure in desired locations. Some areas or appendages of the lure may be very flexible but some areas may need to stay rigid for less flexibility and the means of hardening, forming of melting will allow such features to differ in a lure design. Also, the textile lure body can be formed or set to desired shapes, such as but not limited to “S” shapes, curves, twists, Z patterns and so on. Three-dimensional shapes can be formed and set with a die or methods of forming around a machined or fabricated mandrel or feature.

As described in the background of this invention, coloring of soft lures can be limited, specifically with molding. Hand painted or painted lures can have great detail and appealing to eye but is only on the outer surface of lure. Another feature of this invention is the infinite coloration and detail that can be placed on both sides of the textile lure. Both sides of textile lure have independent capability to infinite coloration and detail. When the textile lure is used in an over-molded or coated applications with a clear or semi clear elastomer or polymer, the printed textile detail is magnified through 3D elastomer or polymer and appears to be colored in all dimensions. This allows for a very realistic transparent or semitransparent look and detail that is limited in other soft lures today.

The textile lure can be used by itself, also, but not limited to, coated or over-molded with elastomers or polymers as described above. The invention of the textile lure incorporated with, but not limited to, an elastomer or polymer body gives a soft lure the planar axis additional strength yet allows for great flexibility while leaving the remaining material virgin. The textile lure used in this application greatly enhances the life and durability of a soft lure. Because of the planar axis strength of the textile lure, lower durometer elastomers can be used that normally would be too soft for a soft lure application. Also, when the textile lure is used with, but not limited to, an elastomer, semi-rigid or rigid polymer, the textile lure allows for attachments or separate segments of these materials along the textile lure body. This allows for great flexibility and strength between segments.

An additional invention that can be used with the textile lure is an attachable mechanism for hook attachment or textile lure attachment. A low profile attachment mechanism body that can be permanently attached to the leading portion of the textile lure. This permanent body includes but not limited to, an eyelet, snap, ring, or bend wire configuration that can be temperately attached to the eyelet of any hook. A mechanism body that can be temporarily attached to the leading portion of the textile lure. This detachable body includes but not limited to, an eyelet, snap, ring, or bend wire configuration that can be temporarily attached to the eyelet of any hook. This detachable mechanism may have detail of the textile lure creature such as a frog head, a minnow head and so on. The mechanism would consist of a strong elastomer, polymer or other materials and would give even more rigidity and longer use of the textile lure. Other molded or fabricated feature attachments used by itself or with other attachments such as but not limited to a body section, bills, propellers, fins, tail, legs, tentacle's, claws, or other designs can be attached to textile lure. Other attachments such as, but not limited to, eyelets, grommets, rattles, weights, hooks, leaders, tethers, wire, swivels, reflective materials, feathers, streamers, beads, capsules, and reservoirs can all be attached to a textile lure.

There are a number of other applications this invention could benefit in the fishing industry. Not only the fishing lure itself, but fishing lure attachments and fish attractors could be made from a textile. For instance jig/hook skirts, spinner blades, socks or sleeves around weights or hooks.

The lures of this invention include: 1) a textile lure body 2) a textile lure treated with heat in specific areas to change flexibility and rigidity or forming in dies or around features 3) plain, dyed, colored, patterned, or printed surfaces on the textile 4) a textile lure body used by itself or coated, dipped or over-molded with elastomer or polymer 5) hook and/or lure attachment mechanism and other attachments 6) fish attractant and lure attachment textiles

Further, the present invention is directed toward the method of manufacturer of the lures.

The textile lure can be cut in any specific shape and size with infinite variability. Many methods can be used to cut the textile but the preferred method is using a CO2 laser. This type of laser can cut the textile without leaving visual oxidation damage or discoloration to the cut areas of the textile and also seal the cut perimeter of the textile lure to prevent loose fibers or fraying. Using the laser cutting method, there is no need for re-tooling and the costs that goes with it. Custom shapes and features can be changed on the fly. Other methods of cutting such as but not limited to are hot knife cutting, hot die cutting, die stamping, steal rule die, and manually cutting.

The coloration design and detail on the textile lure are infinite and can be changed instantly without interrupting the process. Coloration detail can be added prior to cutting or after cutting the textile lure. The preferred method is to color multiple lures on a given sheet or roll of textile. A single side or both sides of textile can be colored. The preferred coloring method is dye sublimation for best color and detail quality on a textile. Also, when the colored textile lure is coated or over-molded with an elastomer or polymer, we have found that the dye sublimation does not affect bond strength of the materials. Other methods of coloring the textile can be done with many different means of coloring such as but not limited to, laser printing, inkjet, plotter, plastisol printing, and hand coloration. For laser cutting, locating features such as dots, cross airs, or other shapes are colored or marked near the lure that is to be cut and the laser vision system is able to locate exactly where it needs to cut based on positioning of this locating feature. The laser uses a vision system to locate this feature. Other coloration or design enhancements can be added to the textile lure. These enhancements can be, but not limited to, fleck, glitter, glue, epoxy, and metallic of different forms, scents, or flavors.

When the textile lure is coated or over-molded with elastomer, polymer, or other materials, the textile is chemically treated with a phosphorous based chemical for enhanced bonding ability to these materials. Without this treatment the two materials are easily delaminated. Other methods of mechanically changing the surface of the textile lure to make more bondable are using fine sand paper to etch the surface work well but decrease the tensile strength of the textile lure.

When the textile lure is used with an elastomer or other flexible or semi-rigid or rigid coating, a desirable thickness can be applied to one or both sides of textile of a given size sheet of textile prior to or after cutting lure profile. Methods of coating can be, but not limited to, spraying, printing, dipping, extruding, or molding. Coatings can also be applied to textile lure after thermoforming a fixed shape or detail. For some lure designs, not the whole lure is desired to be coated and only designated locations can be coated such as hooking locations or desired lure body features. The other areas can easily be masked or blocked with masking tape or other masking agents or fixtures.

When the textile lure is over-molded with a three dimensional body. The textile lure profile is preferably cut with a CO2 laser. The majority of the textile lure profile is cut but small segments are left attached to a larger textile shape that can be pinched between the mold halves to secure the textile lure from moving during the molding operation. With the fill of material into the mold cavity, there is force put onto the textile lure from the pressure of material filling the cavity from the injection system. These small tabs hold the lure in position at the mold parting line during the injection process. By cutting out the majority of the lure profile prior to molding, almost the entire textile lure is recessed into the injected molded material within the cavity. This leaves a very smooth parting line and increases the cosmetics and quality of the lure. These tabs also prevent the manufacturer from cutting out the entire lure after the molding process. These tabs can be designed and sized so that they pull off by hand once lure has been removed from mold. In addition, locating holes or features are cut into the textile surrounding the lure profile. Prior to molding, the textile locating holes or features are placed over protruding features fixed into mold half to align textile perfectly over mold cavity. Although this is the preferred method as previously described other methods have been proven to work as well for over-molding. A solid piece of textile can be over-molded and cut after molding. Methods of cutting used but not limited to die stamps, steal rule die, hot knife, laser cutting, and cutting manually have also proved to work well but not as efficient and result in a greater scrap rate. An additional benefit of the textile lure, the entire textile lure body does not have to be over-molded, for instance, in some lure designs, it may be just the body that is over-molded and the extremities are left as just the textile or the combination of a body with extremities over-molded with just textile between these molded features. Over-molding and cavity location can be place anywhere on textile lure. Another tested method is over-molding a pre-cut textile lure and holding the pre-cut textile lure with pins protruding from both sides of the mold within the part cavity. This method works very well but leaves pin holes in finished part and at times may be less desirable especially in small features. But with that, the small holes left in completed lure can be used as an enhancement for trapping air to make more buoyant or leaving a trail of air bubbles wile fished under water, or used as a reservoir for adding scent or fish attractant.

For both material coatings and over-molding of the textile lure, the materials used can be translucent, tinted or solid color. The materials can also include additives such as metallic flakes, fleck, or sparkles. With a translucent or semi-transparent material the coloring and detail on the textile lure is amplified by magnification through elastomer or polymer appearing the entire lure is colored. With solid to semi-transparent material colors only the thin areas of the lure may show coloring from the textile lure. The textile lure coloration and detail allows options and detail never seen this way before that are not available in the current art of soft lures. The ability to change color and color detail in any area of the lure on the fly with both the textile coloring and/or combined with over-molded or coated material coloration as disclosed has never been done before and will add great value and color configurations never seen before.

The invention disclosed herein addresses the deficiencies and limitations of the lures of current art. The textile lure itself or incorporation with an elastomer or polymer coating or over-molded body, and coloration provide lures with strength, flexibility, action, appearance and durability which up to this time has not been possible.

The object and advantages of this invention will appear more fully from the following detailed description of the preferred embodiment of the invention made in conjunction with the accompanying drawings.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a top planar of an exemplary lure

FIG. 1A is a side view of FIG. 1

FIG. 1B is an isometric view of FIG. 1

FIG. 2 is an isometric view of an exemplary lure

FIG. 2A is a detail view of FIG. 2

FIG. 3 is a top view of thermally set or formed exemplary lure

FIG. 3A is a side view of FIG. 3

FIG. 3B is an isometric view of FIG. 3

FIG. 3C is an isometric view of thermally set or formed exemplary lure

FIG. 4 is an isometric view of thermally set or formed exemplary lure

FIG. 4A is and isometric view of thermally set or formed exemplary lure with cutouts for flexibility

FIG. 5 is an isometric view of exemplary lure hooking method example 1

FIG. 5A is an isometric view of exemplary lure hooking method example 2

FIG. 5B is an isometric view of exemplary lure hooking method example 3

FIG. 5C is a side view of FIG. 5B

FIG. 5D is an isometric view of exemplary lure hooking method example 4

FIG. 5E is an isometric view of exemplary lure hooking method example 5

FIG. 6 is an isometric view of exemplary lure coloring detail

FIG. 6A is an image of creature detail used on exemplary lures

FIG. 6B is an image of creature detail layout used on exemplary lures

FIG. 6C is an image of final creature detail layout used on exemplary lure

FIG. 6D is an isometric view of creature detail on exemplary lure over-molded

FIG. 6E is a side view of FIG. 6D

FIG. 7 is an isometric view of exemplary lure coloring detail

FIG. 7A is an image of creature detail used on exemplary lures

FIG. 7B is an image of creature detail layout used on exemplary lures

FIG. 7C is an image of final creature detail layout used on exemplary lure

FIG. 7D is an isometric view of creature detail on exemplary lure over-molded

FIG. 7E is a side view of FIG. 6D

FIG. 8 is an isometric view of coated exemplary lure

FIG. 8A is a side view of FIG. 8

FIG. 8B is a detailed view of FIG. 8A

FIG. 8C is an isometric view of FIG. 8 with coloring

FIG. 9 is an isometric view of over-molded exemplary lure

FIG. 9A is a side view of FIG. 9

FIG. 9B is an isometric view of partially over-molded exemplary lure

FIG. 9C is a side view of FIG. 9B

FIG. 10 is an isometric view of over-molded exemplary lure with hooking method example

FIG. 10A is a side view of FIG. 10

FIG. 10B is an isometric view of over-molded exemplary lure with hooking method example

FIG. 10C is a side view of FIG. 10B

FIG. 11 is an isometric view of exemplary hook attachment mechanism

FIG. 11A is an isometric view of FIG. 11

FIG. 11B is an isometric view of exemplary hook attachment mechanism with exemplary lure

FIG. 11C is an isometric view of exemplary hook attachment mechanism assembled on exemplary lure

FIG. 11D is an isometric view of FIG. 11C with hook

FIG. 11E is an isometric view of exemplary hook attachment mechanism on exemplary lure over-molded

FIG. 11F is an isometric view of FIG. 11E with hook

FIG. 11G is a side view of FIG. 11F

FIG. 12 is an isometric view of exemplary detachable mechanism on exemplary lure

FIG. 12A is an isometric view of exemplary detachable mechanism detached from exemplary lure

FIG. 12B is an isometric view of exemplary detachable mechanism and exemplary lure attachment

FIG. 12C is an isometric view of exemplary detachable mechanism in open position

FIG. 12D is a top view of exemplary detachable mechanism in closed position with section defined

FIG. 12E is a side section view of exemplary detachable mechanism in closed position

FIG. 13 is an isometric view of exemplary skirted jig application

FIG. 13A is a top view of exemplary skirt application

FIG. 14 is a side view of exemplary spinner application

FIG. 14A is a side view of an additional exemplary spinner application

FIG. 15 is an isometric view of exemplary textile insert for over-molding and exemplary manufacturing methods

FIG. 15A is a top view of FIG. 15

FIG. 15B is an isometric view of exemplary mold assembly with exemplary textile insert and exemplary manufacturing methods

FIG. 15C is an isometric view of exemplary textile insert over-molded product

FIG. 15D is an isometric view of exemplary lure removed from textile insert

### DETAILED DESCRIPTION OF THE INVENTION

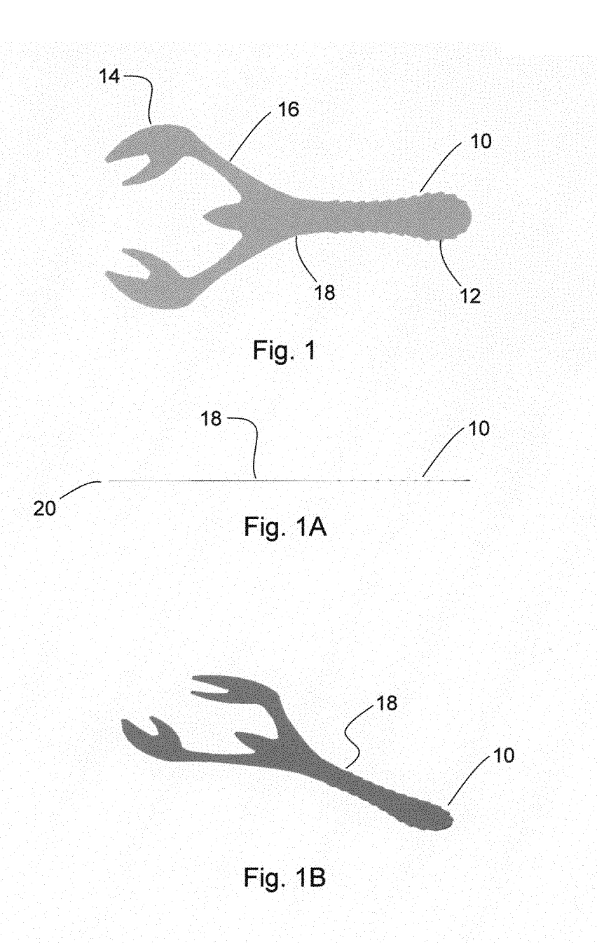

### Referring to FIG. 1

FIG. 1 is a top view of lure 10 which is an example shape for the body of a crawfish lure. The method of attachment will be described in subsequent drawings. The lure has a body portion 12 and extremities portion 14. The extremities are attached by thin arms 16. Lure 10 is made of a textile 18. FIG. 1A which is a side view of lure 10. Lure 10 made entirely of a textile 18 shown in this view demonstrates the thickness 20 of textile lure. The thin nature of the textile 18, lure 10 gives great flexibility and strength. FIG. 1B is an isometric view of lure 10 made of textile 18. Any lure design or shape can be derived from textile 18. All lure designs shown in subsequent drawings are examples of, but not all design options. Designs are unlimited. The preferred textile 18 material is generally formed of but not limited to polyester, nylon, polyurethane or hydro-carbon or carbon based materials which are biodegradable. The textile 18 may be comprised of either a fixed node, or a floating node construction. The term fixed node construction is used to describe a matrix where the intersections are generally joined. An example of this general configuration is a screen. The term floating node constructed is used to describe a matrix where the intersections are generally movable with respect to the intersections. An example of this configuration is a weave or braid. Both configurations are anticipated by this disclosure.

The design requirements of the textile 18 lure material dictate that the material should be quite thin, but strong. Although thickness can be variable, the preferred embodiment the thickness should be no more than 1 mm, and more preferably≤0.2 mm. The tensile strength can be variable as well, based on the size of the lure and size of the hook used, the preferred tensile strength needs to be greater than 2.25 kilograms per cm of width, and more preferably a factor of at least 2 times this, and even more preferably 10 times this value. The textile 18 must increase the tensile and shear properties of the tiny extremities, and the hook retention areas by a factor of at least 2 times that of an un-reinforced soft plastic counterpart to meet the design objectives that fishermen desire. The materials used should provide a matrix that is strong in tensile and flexible in bending. This is because the tensile stiffness of artificial lures that are comprised from elastomeric materials is inadequate in this axis and fall apart far too quickly under real use.

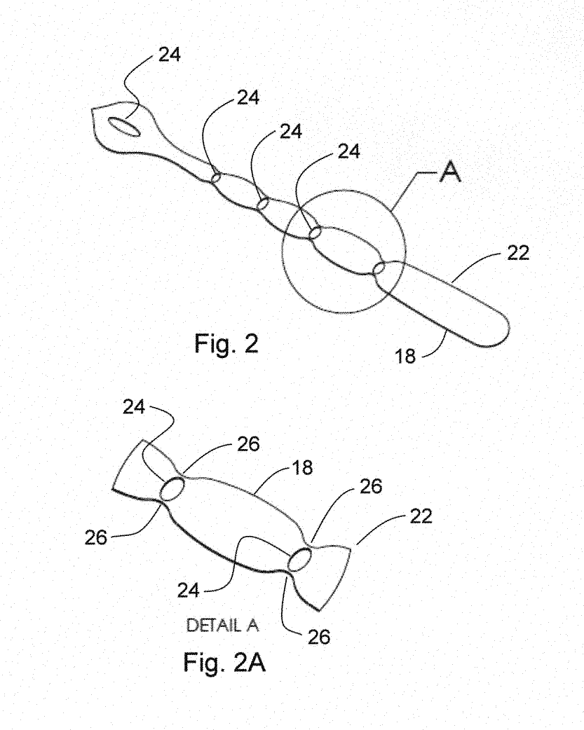

FIG. 2 is an isometric view of lure 22 which is another example shape for the body of a worm or leech design. The method of attachment will be described in the subsequent drawings. Lure 22 is made entirely of a textile 18. Lure 22 has additional cutouts 24 for design purposes, cosmetics, and but not limited to flexibility. FIG. 2A is a detailed view of a portion of lure 22 of FIG. 2. In this view the cutouts 24 can be added to give textile 18 lure 22 very thin areas 26 for great flexibility. Being the lure is made entirely of a textile 18, these thin areas 26 are very strong but yet flexible.

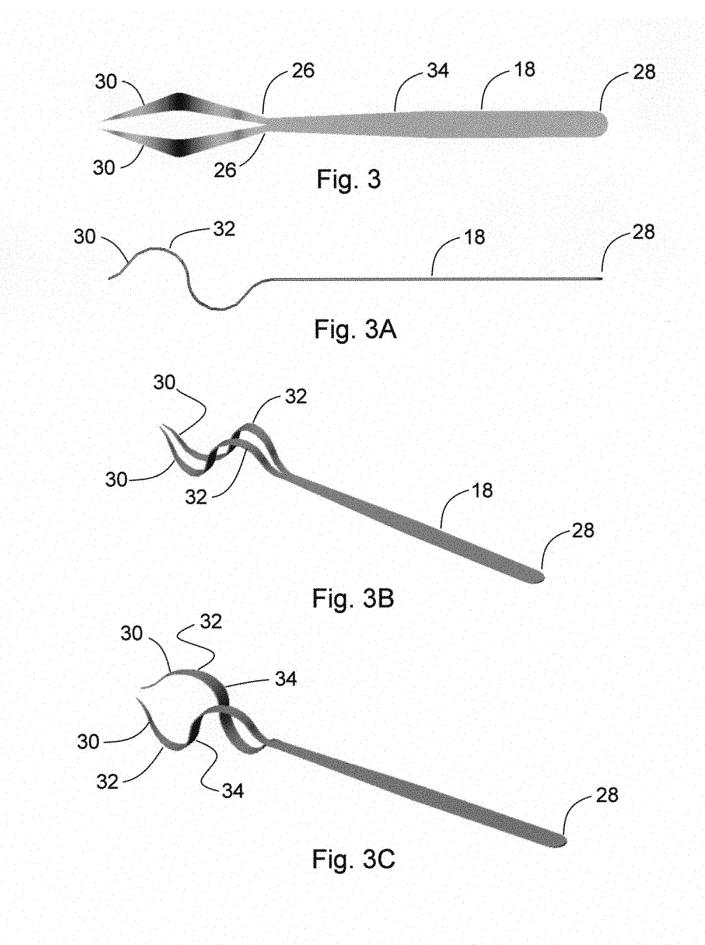

FIG. 3 is a top view of lure 28 which is an example shape of a tailed worm design made entirely of a textile 18. The tail sections 30 is attached to lure body 34 by very thin areas 26 for great flexibility and motion in the water. FIG. 3A is a side view of textile 18 lure 28 with tail sections 30. The textile 18 of lure 28 shows an example of a thermally set or formed 32 tail sections 30 in an “S” shape fixed position. These thermal sets or forms 32 will remain fixed but yet have enough flexibility in the water for great motion to attract, look lifelike, and look appealing to fish. FIG. 3B is an isometric view of lure 28 made entirely of a textile 18. This isometric view shows greater detail of thermal set or formed 32 tail sections 30. FIG. 3C is an isometric view of a similar lure as lure 28 with tail sections 30 thermally set or formed 32 in opposing directions 34. FIG. 3A, FIG. 3B, and FIG. 3C is just an example of thermal sets or forms 32 in the tail sections 30 and is not limited to any shape, size or areas of the desired lure design.

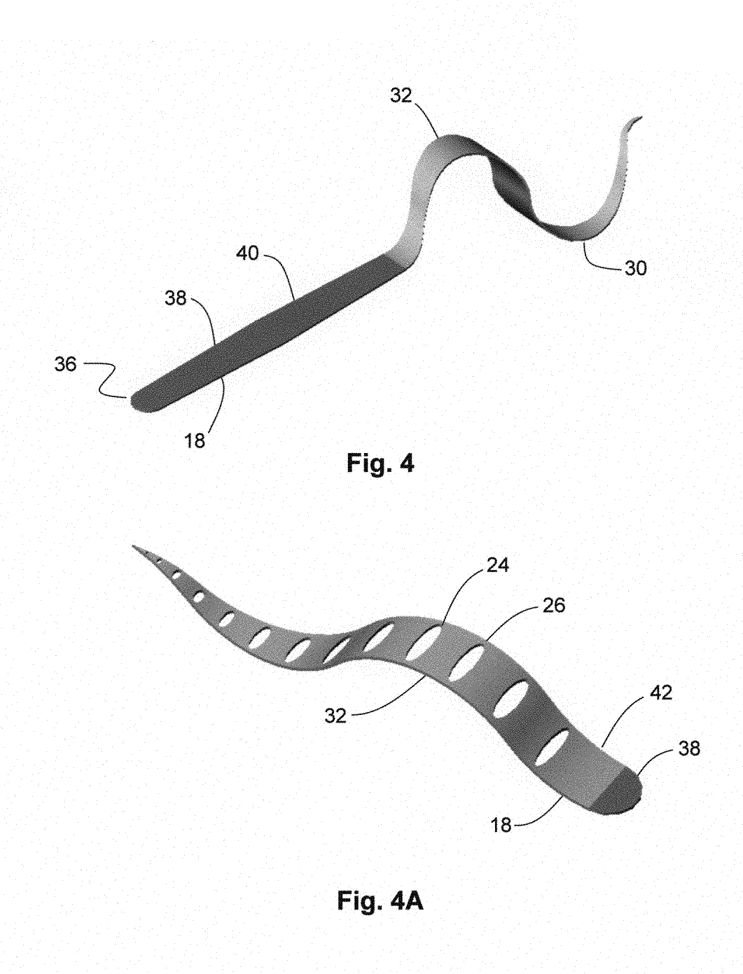

FIG. 4 is an isometric view of lure 36 which is an example shape of a worm made entirely out of a textile 18. Lure 36 has a tail section 30 and is thermally set or formed 32 as shown but not limited to an “S” shape. The body 40 of lure 36 shows the textile 18 thermally set 38 to the point it makes the body 40 section of the lure 36 more rigid. Textiles 18 can be thermally treated 38 with various temperatures to get the desired harness desired. Not only does this make the textile 18 lure 36 body 40 more rigid for less flexibility in this area but also aids in greater hook retention. FIG. 4A is an isometric view of lure 42 which is an example shape of a leech design made entirely out of a textile 18. Lure 42 is shown thermally set or formed 32 in an “S” shape. This lure 42 may not require a thermal set or form 32 because of the cutouts 24 and thin areas 26 of textile 18 will have much flexibility when “twitched” in the water. Lure 42 also shows an example of a thermally set 38 “tip” where it is hooked.

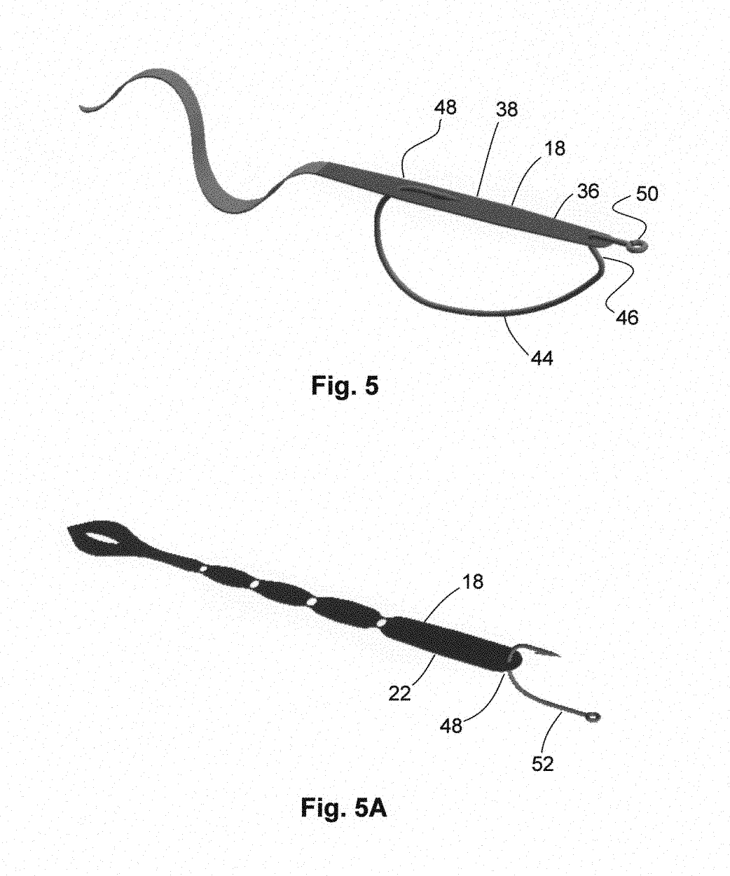

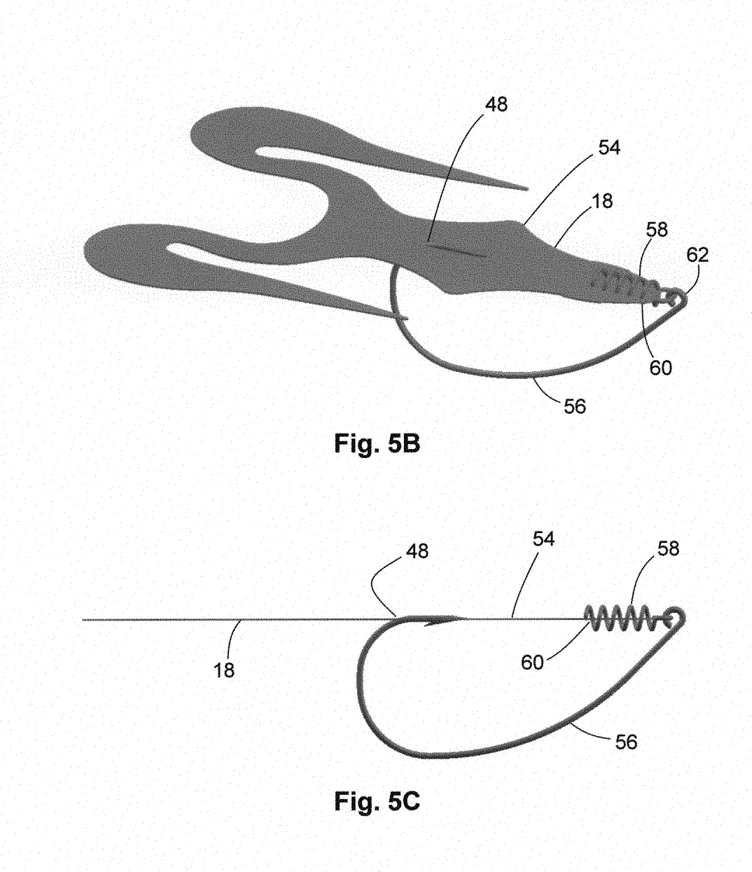

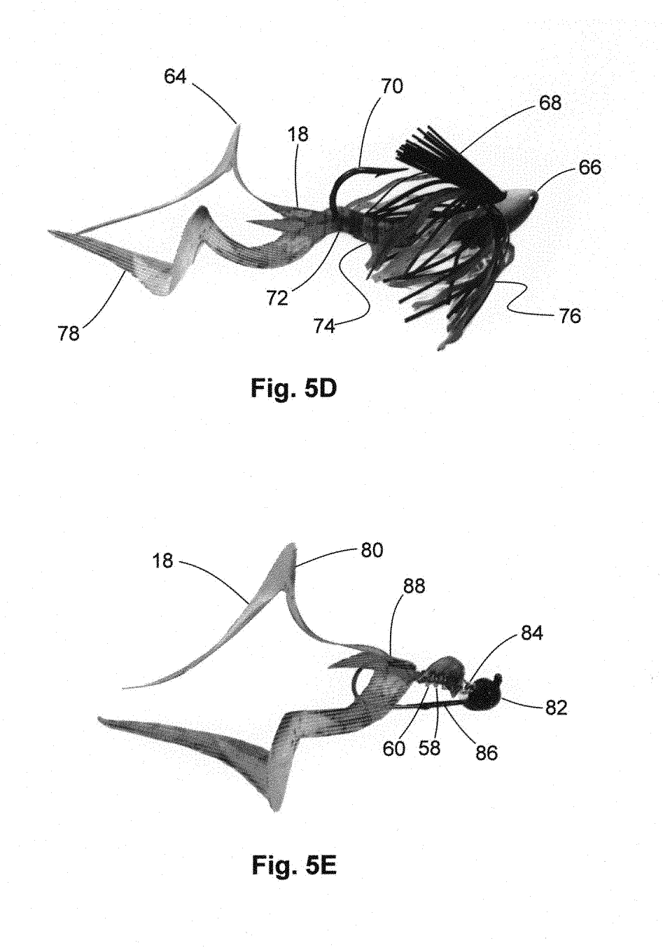

FIG. 5 is an isometric view of lure 36 shown as an example of one of many ways the textile 18 lures can be hooked. Hook 44 is an off the shelf hook commonly known as a “worm hook” or “wide gap worm hook”. This style of worm hook has a bend 46 near the eyelet 50 of the hook where the fishing line is tied. This type of hook 44 works well with the textile 18 lures because the bend 46 seats well and retains the textile 18 lures in a fixed position when fished. The “sharp” or “barbed” end of the hook 44 when pushed through the textile 18 or thermally set 38 textile 18 as shown in lure 36, retains in hooking location 48 the hook 44 and the lure 36 in a fixed position when fished. FIG. 5A is an isometric view of lure 22 hooked thru the textile 18 with an “octopus” style hook 52. This lure 22 and hook 52 is shown rigged for “finesse” fishing and hooked just within the tip of the textile 18 lure 22. The textile 18 lures allow for such hook 52 and hooking location 48 because of its tensile strength and would normally be difficult hooking this way with regular soft plastic baits because the plastic tears so easily. With current soft plastics today, the hooks are normally embedded further into soft plastic body to gain increased strength with larger cross section of soft plastic body. Because of this, the hook 52 (as shown) hooking surface is minimized due to the increased soft plastic in the hooking areas of the hook and hooking percentage of fish decreases. With some soft plastics, other devices are added to the plastic lure to achieve a more “exposed” hook for increased hook exposure which in turn increased fish hooking percentage. Some of these methods are an O-ring secured around the soft plastics and the hook is attached around the O-ring and another example is a metal coil with an eyelet which is screwed into the soft plastic that allows deeper penetration for increased strength and then the hook is pushed through the eyelet of the coil at the tip of the lure. These are just some of the methods used today to help prolong the life and durability of soft plastics today but is still very limited to how long they will hold up before breaking and the textile 18 lures is solution that does not exist today that every fisherman can benefit from for extended durability with any hooking method. FIG. 5B is an isometric view of lure 54 shown as an example of a frog design made entirely of a textile 18. This embodiment shows an example of a hook 56 also known as a “swim bait hook” with a cork screw 58. The cork screw 58 of hook 56 can be turned by helix 60 into the textile 18 to fix the front end of the lure 54 near the eyelet 62 of the hook 56. Because the cork screw 58 is turned by helix 60 into the textile 18 many times, each entry point of turned by helix 60 into the textile 18 is an anchor point and disperses the load or stress on the lure to all these points turned by helix 60 making this a very strong hooking method. The “sharp” or “barbed” end of the hook 56 when pushed through the textile 18 as shown in lure 54, retains in hooking location 48 the hook 56 and the lure 54 in a fixed position when fished. FIG. 5C is a side view of lure 54 and the hook 56 with cork screw 58 turned by helix 60 into textile 18 and secured at hooking location 48 on “sharp” or “barbed” end of hook 56. FIG. 5D is an isometric view of lure 64 shown as an example of a textile 18 swimbait attached to a weed less brush guard 68 jig 66. These styles of jigs 66 are an existing and commonly known and used hook for many fisherman given their versatility when used is weedy areas, timber, and rocks without snagging. These Jigs 66 can include plastic, or silicone skirts 76 and are often tipped with a soft plastic lure on the hook 70 of the jig 66. A common issue as described previously is that the soft plastic does not hold up long with this type of rigging. The textile 18 lure 64 (shown in this example), is hooked once 74 thru the leading edge of the textile 18 lure 64, then again a second time 72 a little further down thru the textile 18 lure 64 fixing the lure securely on the jig 66. Lure 64 is a textile 18 swimbait which has a very flexible leg design 78 which create a kicking motion in the water perfect for using on such jigs 66. FIG. 5E is an isometric view of lure 80 which is another example of a swim style textile 18 lure attached to a “shaky head” style finesse jig 82. This jig 82 shows an example of one of the many styles with the cork screw 58 attachment method. As described previously, the cork screw 58, is turned many times into the textile 18 lure 80 giving many anchor points 60 for great lure retention and durability. The cork screw 58 is attached to jig 82 on the inside of the jig as shown 84. The hook portion 86 of the jig 82 is secured at location 88 thru the textile 18 lure body 80.

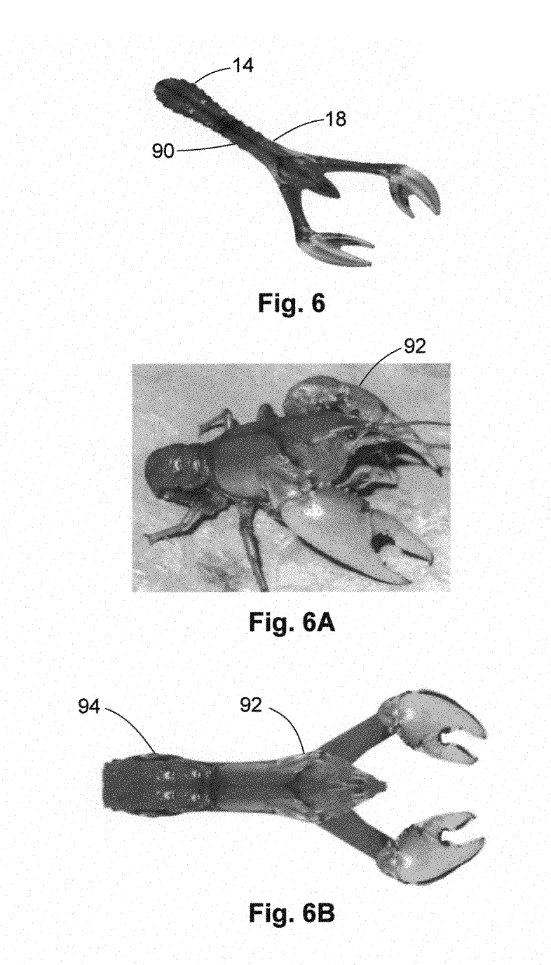

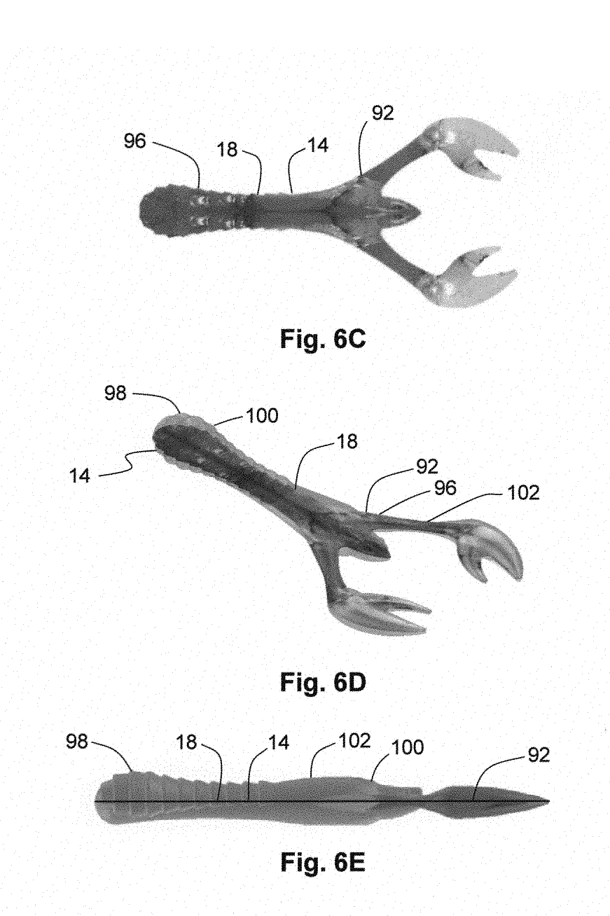

FIG. 6 is an isometric view of lure 14 which is a lure entirely made of textile 18. Lure 14 is shown with lifelike color detail 90 of a crawfish. The lifelike color detail 90 of a crawfish is shown as one example of the unlimited color options that can be put on the textile 18 lures. Unlike coloration of molded soft plastics, which colorations are limited to the molding process (as described previously in the summary of this invention) and detail with coloration has limitations, coloring of the textile 18 lures has no limitations. FIG. 6A shows how realistic creature or prey detail such as the crawfish image 92 shown as just as one example that can be used on the textile lure. FIG. 6B shows the crawfish color detail 92 laid out to fit the textile lure as the first step 94. FIG. 6C shows the second step of fitting the crawfish color detail 92 on the textile 18 lure 14 actual size 96. This step allows the detail to match the actual features on the lure 14. FIG. 6D shows the example textile 18 lure 14 with color detail of the crawfish 92 fit to the actual size 96 of lure 14. Textile 18 lure 14 is shown over-molded 98 with a soft, clear elastomer or polymer 100 in this example. The clear elastomer or polymer 100 allows the color detail of the crawfish 92 in this example and appears to look three dimensional through amplification of elastomer or polymer 102 thru the clear over-molded body 98. FIG. 6E is a side view of textile 18 lure 14 with crawfish detail 92 over-molded 98 with clear elastomer or polymer 100. The crawfish detail is not seen in this view because it is colored on the top and/or bottom side of the textile 18 but with the amplification thru elastomer or polymer 102 it will appear to be color three dimensionally 102 but with difficulty to illustrate this, it is being described in text and not shown in FIG. 6E.

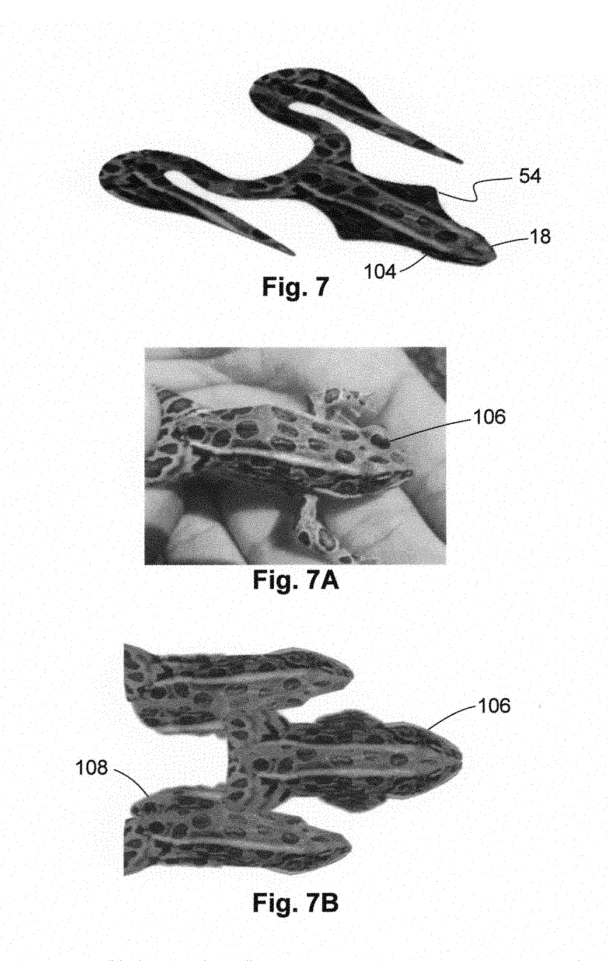

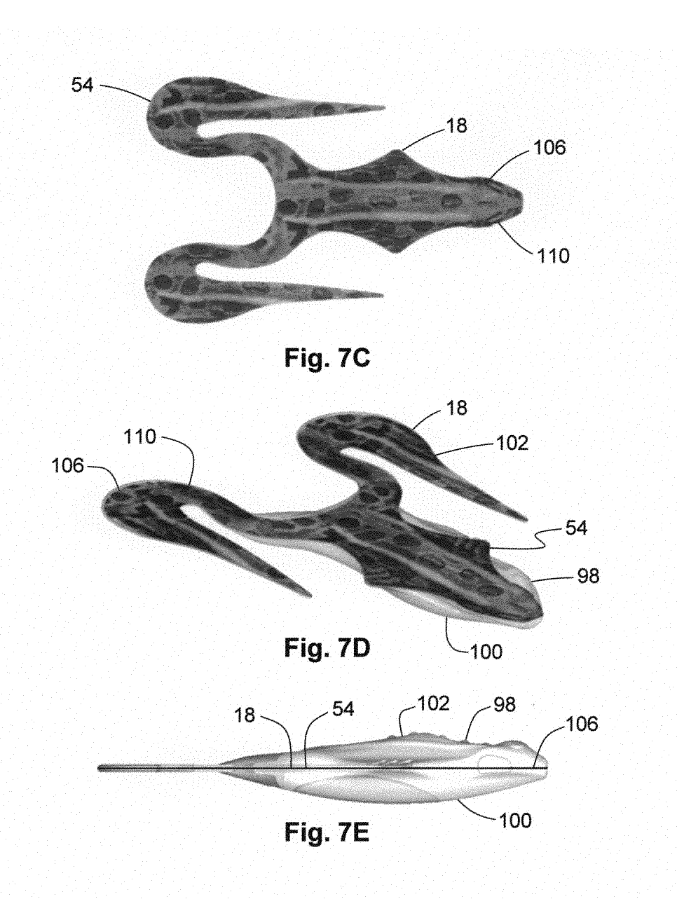

FIG. 7 is an isometric view of lure 54 which is a lure entirely made of textile 18. Lure 54 is shown with lifelike color detail 104 of a frog. The lifelike color detail 104 of a frog is shown as another example of the unlimited color options that can be put on the textile 18 lures. Unlike coloration of molded soft plastics, which colorations are limited to the molding process (as described previously in the summary of this invention) and detail with coloration has limitations, coloring of the textile 18 lures has no limitations. FIG. 7A shows how realistic creature or prey detail such as the frog image 106 shown as just as another example can be used on the textile lure. FIG. 7B shows the frog color detail 106 laid out to fit the textile lure as the first step 108. FIG. 7C shows the second step of fitting the frog color detail 106 on the textile 18 lure 54 actual size 110. This step allows the detail to match the actual features on the lure 54. FIG. 7D shows the example textile 18 lure 54 with color detail of the frog 106 fit to the actual size 110 of lure 54. Textile 18 lure 54 is shown over-molded 98 with a soft, clear elastomer or polymer 100 in this example. The clear elastomer or polymer 100 allows the color detail of the frog 106 in this example and appears to look three dimensional through amplification of elastomer or polymer 102 thru the clear over-molded body 98. FIG. 7E is a side view of textile 18 lure 54 with frog detail 106 over-molded 98 with clear elastomer or polymer 100. The frog detail is not seen in this view because it is colored on the top and/or bottom side of the textile 18 but with the amplification thru elastomer or polymer 102 it will appear to be colored three dimensionally 102 but with difficulty to illustrate this, it is being described in text and not shown in FIG. 6E.

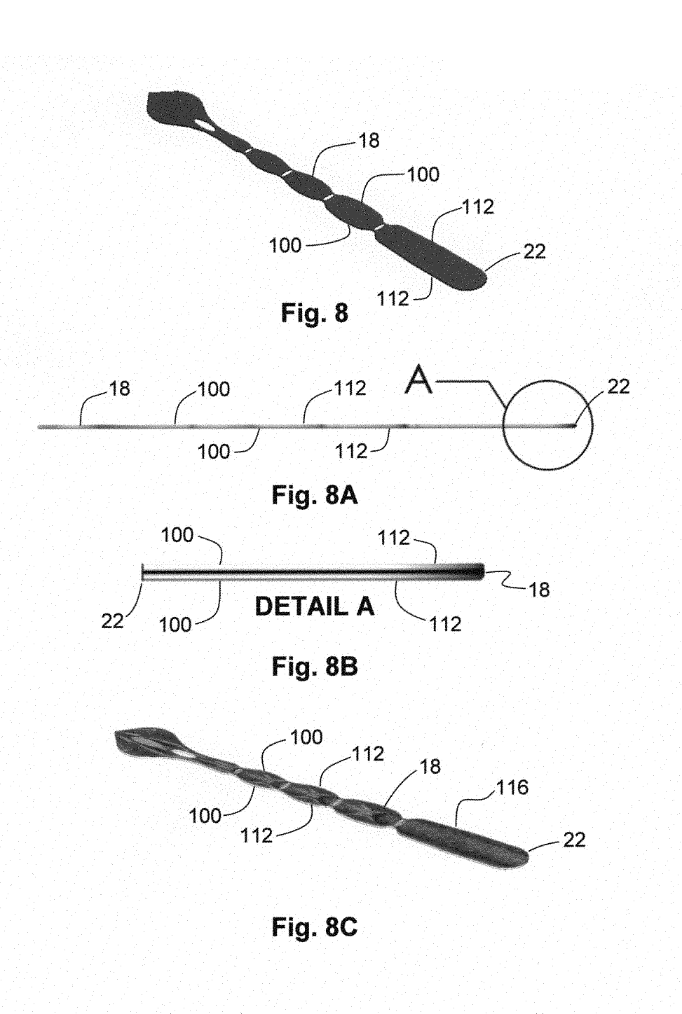

FIG. 8 is an isometric view of lure 22 which is an example of a leech or worm design that is made of textile 18 and coated 112 with an elastomer or polymer 100. Coating 112 the textile 18 lures allows for a very thin, soft, and very flexible lure 22 that is not available today with soft plastics. FIG. 8A is a side view of lure 22 made of textile 18 and coated 112 with an elastomer or polymer 100. The side view illustrates the very thin, soft, and very flexible capabilities of this lure 22 coated with elastomer or polymer 100. FIG. 8B is a detailed view for clarification of lure 22 made of textile 18 coated 112 with a thin layer of elastomer or polymer 100 on both sides of textile 18 lure 22. Coating 112 can be of any thickness desirable or various thicknesses on a single lure (not illustrated). In addition, the textile 18 lures can be masked or not coated in any area desirable as well as fish on its own as described previously. FIG. 8C is an isometric view of lure 22 made of textile 18 colored 116 with any desirable detail and coating 112 with elastomer or polymer 100.

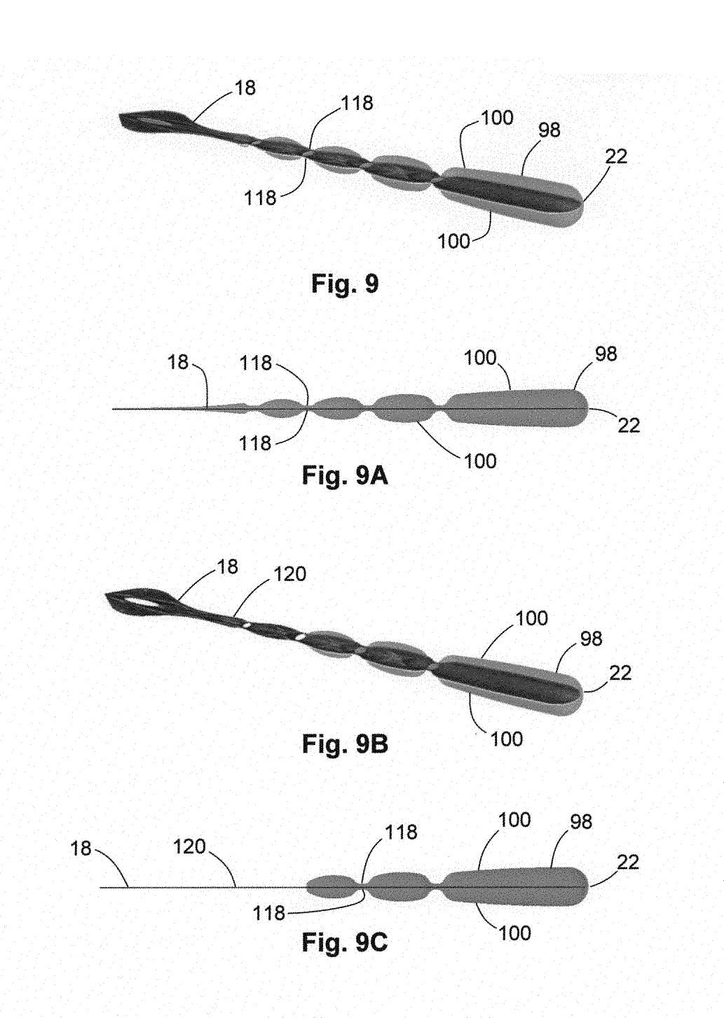

FIG. 9 is an isometric view of lure 22 made of textile 18 shown over-molded 98 with an elastomer or polymer 100. Because of the strength of the textile 18, very thin sections 118 can be over-molded 98 into the textile 18 lures. These thin sections 118 would tear apart very easily without the textile 18 lure. FIG. 9A is a side view of lure 22 made of textile 18 shown over-molded 98 with and elastomer or polymer 100. The side view gives greater detail to the very thin sections 118 of this over-molded 98 textile 18 lure 22. FIG. 9B is an isometric view of lure 22 made of textile 18 shown over-molded 98 with an elastomer or polymer 100 in just front portion of the lure 22. The tail section of the lure is left un-molded 120 and is only textile 18. The over-molded 98 section gives body to the front portion of the lure and leaves the very thin and flexible textile 18 for the tail portion. Any area of the textile 18 lures can be over-molded 98 or not molded or as described previously, fished just as a textile 18 lure. FIG. 9C is a side view of lure 22 made of textile 18 shown over-molded 98 with an elastomer or polymer 100 in just the front portion of the lure 22. The side view gives greater detail to the very thin sections 118 of this over-molded 98 textile 18 lure 22 and shows the un-molded portion 120.

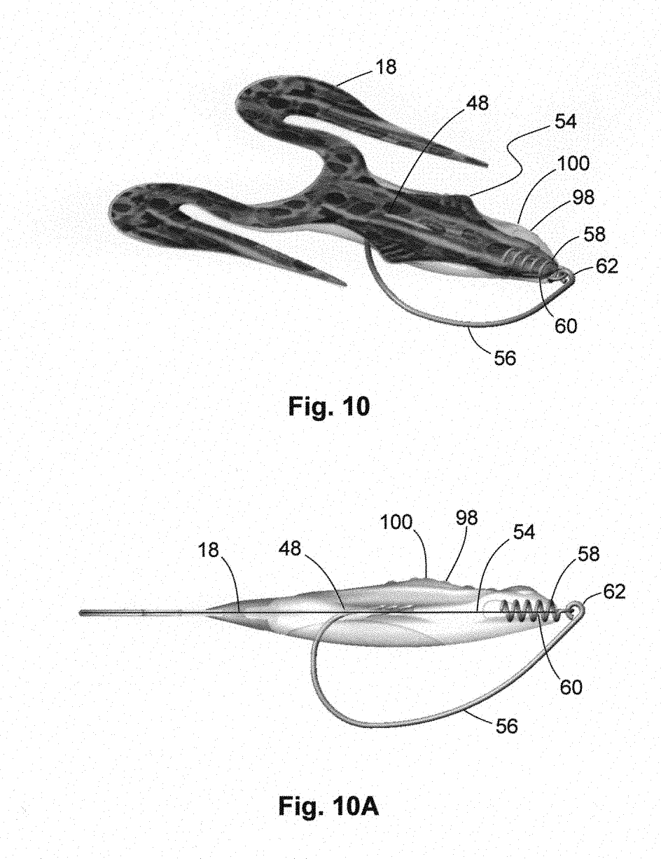

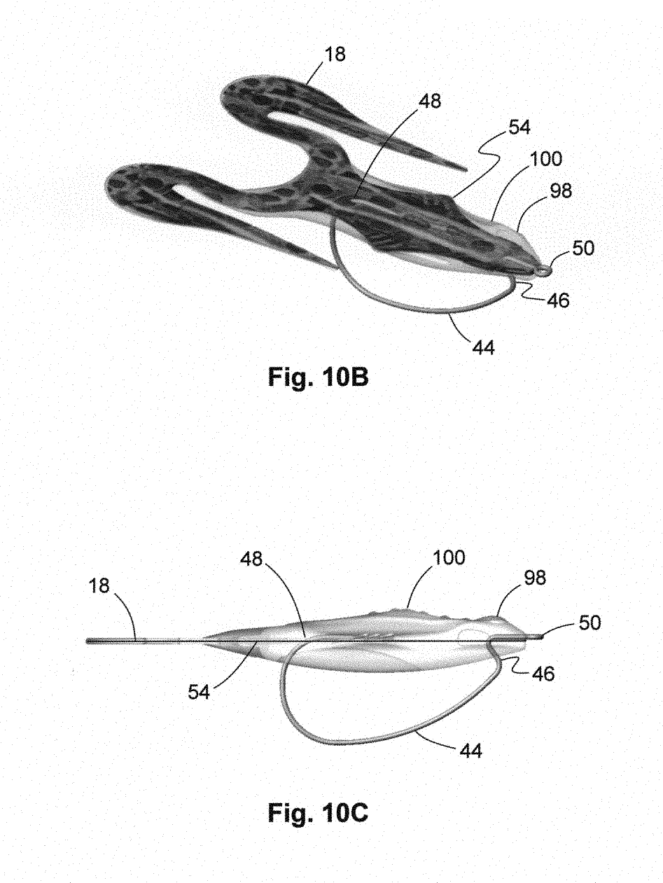

FIG. 10 is an isometric view of lure 54 shown as an example of a frog design made entirely of a textile 18 and over-molded 98 with an elastomer or polymer 100. This example shows an example of a hook 56 also known as a “swim bait hook” with a cork screw 58. The cork screw 58 of hook 56 can be turned by helix 60 into the textile 18 and over-molded 98 elastomer or polymer 100 to fix the front end of the lure 54 near the eyelet 62 of the hook 56. Because the cork screw 58 can be is mechanically attached by helix 60 into the textile 18 and elastomer or polymer 100 many times, each entry point by helix 60 is an anchor point and disperses the load or stress on the lure to all these points making this a very strong hooking method. The “sharp” or “barbed” end of the hook 56 when pushed through the textile 18 and elastomer or polymer 100 as shown in lure 54, retains at hooking location 48 the hook 56 and the lure 54 in a fixed position when fished. This hooking method is used on plastics today and when cork screw 58 in turned into only soft plastic lures without the invention of the textile 18 lures, the coils tear out the front of the soft plastic lure very easily. The textile 18 lures (lure 54 shown) allow for a very secure anchoring location 60 that will not allow for easy tearing or hook “slide downs” within the elastomer or polymer 100 body. FIG. 10A is a side view for greater detail of hooking method into textile 18 lure 54 over-molded 98 with an elastomer or polymer100 as described above in FIG. 10. FIG. 10B is an isometric view of lure 54 shown as an example of one of many ways the textile 18 lures over-molded 98 with elastomer or polymer 100 can be hooked. Hook 44 is an off the shelf hook commonly known as a “worm hook” or “wide gap worm hook”. This style of worm hook has a bend 46 near the eyelet 50 of the hook where the fishing line is tied. This type of hook 44 works well with the textile 18 lures over-molded 98 because the bend 46 seats well and retains the textile 18 lures over-molded 98 in a fixed position when fished. The “sharp” or “barbed” end of the hook 44 when pushed through the textile 18 and over-molded 98 body, retains at hooking location 48 the hook 44 and the lure 54 in a fixed position when fished. FIG. 10C is a side view for greater detail of hooking method into textile 18 lure 54 over-molded 98 with an elastomer or polymer100 as described above in FIG. 10B.

Over-molding the textile lures will not only give a soft plastic bait great strength and durability, durable small features, much greater hook retention, and color options never seen before, but with the planar axial of the textile stretches very little and gives the moving appendages such as but not limited to legs, tails claws etc. action in the water you cannot get with just a soft plastic. The movement can be explained as very “lifelike” or “disruptive” that drives fish love.

Also, when the textile lure is over-molded, the textile is generally incorporated through the centerline of the elastomer or polymer body and is configured to provide planar support throughout the entire body for the purpose of reinforcing the tear resistance, while not significantly impacting bending or flexibility. As may be observed, the textile extends into the small features such as tail, legs, or claws for example. This is a particularly important feature of this invention. The small features of the textile lures illustrated by examples but not limitation needs to be tough but flexible. These features splash around in the water or move when underwater making the bait seem realistic to the fish. These features also are the first to be torn off when the fish interacts with the bait, either in an attack or examination.

In addition when over-molding the textile lure, the textile may not necessarily be placed down the centerline of the lure, and is generally but not necessarily placed in a single layer throughout the body of the fine features.

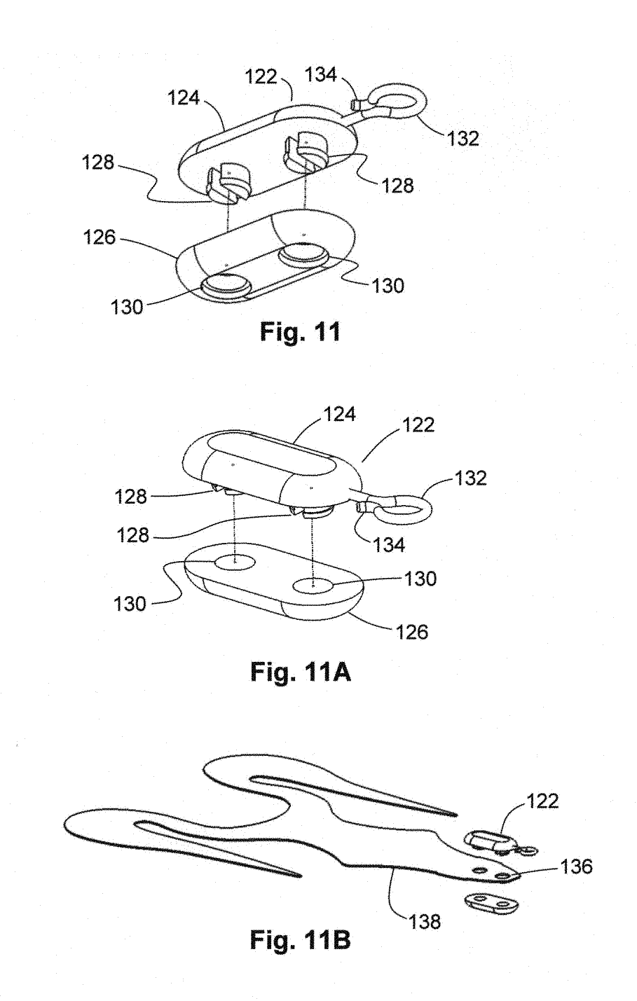

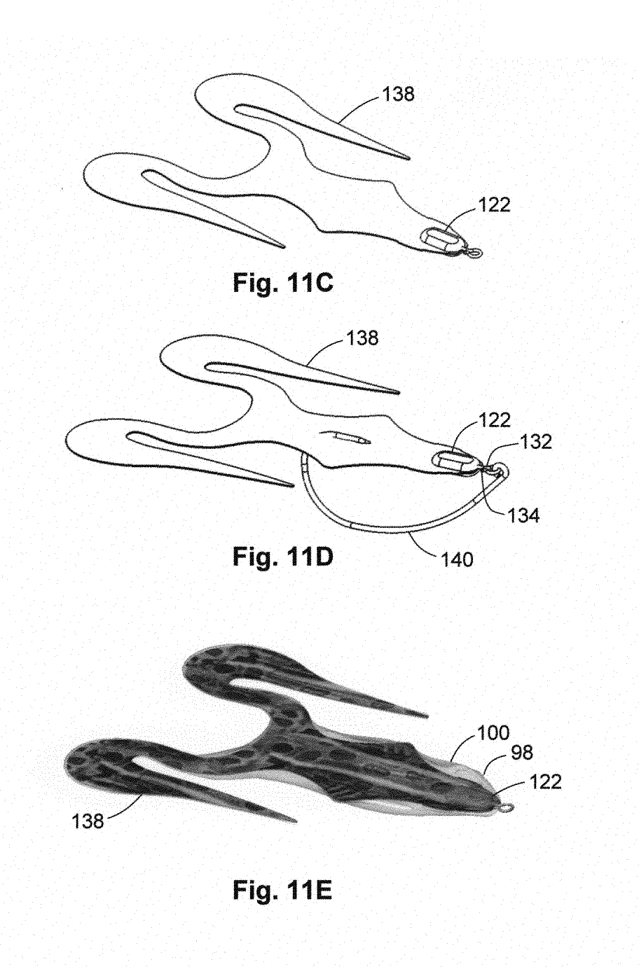

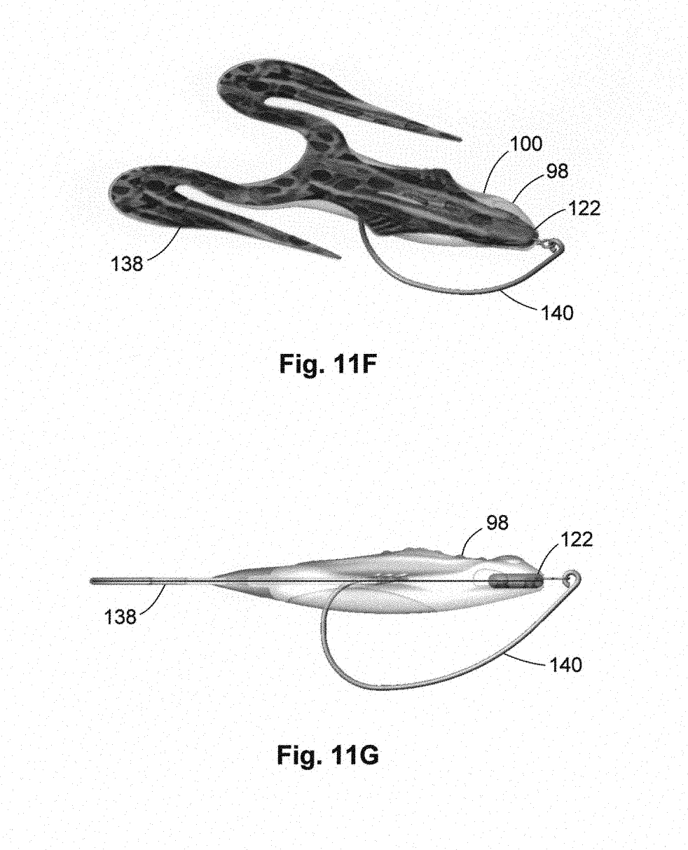

FIG. 11 is an isometric view of a fixed attachable mechanism 122 that attaches to the textile lure and the eyelet of a hook. The attachable mechanism shown is only an example of the many ways this type of disclosed mechanism could be constructed or fixed to textile lure or hook. The shown attachable mechanism 122 has a wire or eye formation 132 designed to snap 134 onto the eyelet of a hook and also be detachable from the eyelet of a hook. The wire or eye formation 132 is over-molded into a low profile upper body segment 124 made of but not limited to a polymer. There are barbed “pins” 128 that are part of the upper body segment 124 that are design to go through the textile lure and into the bottom body segment 126 with mating receiver 130 that lock barbs in place. This allows the locking of the attachable mechanism 122 to the textile lure. FIG. 11A is an addition isometric view for detail of FIG. 11. FIG. 11B shows fixing location of attachable mechanism 122 thru pre-cut holes or features 136 in the textile lure 138. FIG. 11C shows the attachable mechanism 122 fixed onto the textile lure 138. FIG. 11D shows the attachable mechanism 122 fixed onto the textile lure 138 and wire form 132 attached to hook 140 eyelet by wire form 132 snap 134. FIG. 11E shows the attachable mechanism 122 fixed onto textile lure 138 over-molded 98 with an elastomer or polymer 100. The attachable mechanism 122 works with a textile lure, coated textile lure, or over-molded textile lure. This mechanism will allow for easy lure attachment and removal of hook and even greater durability for fixed hook attachment anchor point. FIG. 11F is an isometric view of FIG. 11E with hook 140 attached to attachment mechanism 122 fixed onto textile lure 138 over-molded 98 with an elastomer or polymer 100. FIG. 11G is a side view of FIG. 11F for greater detail of over-molded 98 textile lure 138 with fixed attachment mechanism 122 attached to hook 140.

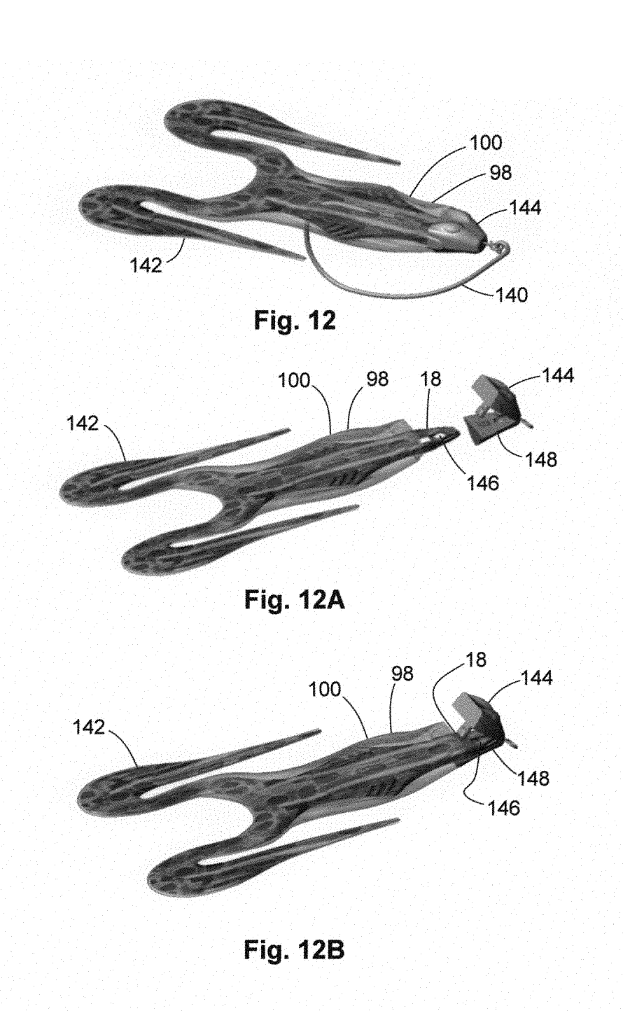

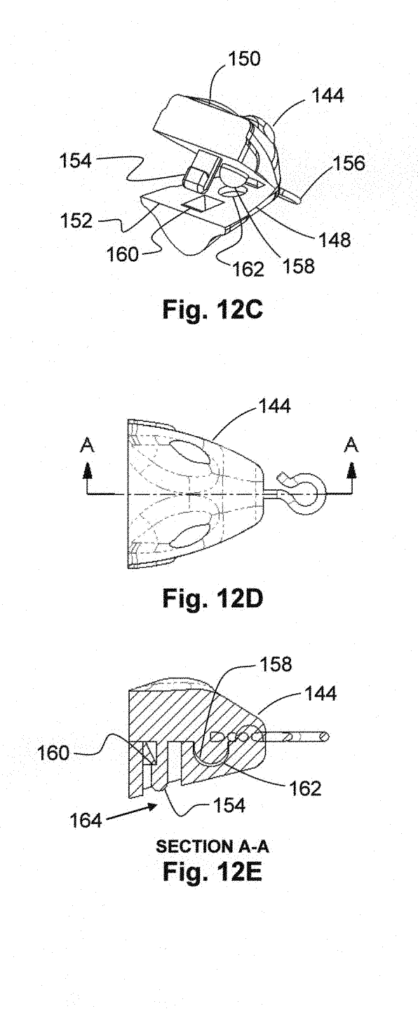

FIG. 12 is an isometric view of a detachable mechanism 144 attached to example over molded 98 with elastomer or polymer 100 on textile lure 142 and hook 140. This allows the user to attach to and detach the lure 142 from the over-molded 98 textile lure 142 and switch lures easily. The detachable mechanism 144 is shaped like a creature leading portion such as a head, tail, etc., this example is a frog head. Not only does this detachable mechanism allow user to switch baits easily but it also give rigidity to the leading portion of the lure and will hold up very well when pulled thru thick weeds, timber, rocks etc. It also gives a very secure fixed attachment to the textile lure 142 and the hook 140. FIG. 12A is an isometric view of the detachable mechanism 144 detached and in the open position 148. The over-molded 98 textile lure 142 will have thru holes 146 for the securing detachable mechanism 144 to the textile 18. The area on the over-molded 98 lure 142 where the detachable mechanism 144 attaches may not be over-molded 98 or may have a thin coating of elastomer or polymer 100. This allows for a very secure fixed position of the detachable mechanism 144. FIG. 12B is an addition view of FIG. 12 with the detachable mechanism 144 shown in attachment position on over-molded 98 textile lure 142. FIG. 12C is an isometric view of the detachable mechanism 144 in open position 148 for greater detail. The detachable mechanism 144 has a top portion 150 and a bottom portion 152 that is made of but not limited to a polymer. A wire form or eyelet 156 is over-molded or assembled into the top portion 150 or bottom section 152 for hook attachment. The top portion 150 also has but not limited to two features that protrude thru the textile for attachment. The leading protrusion 158 acts as a locating fixture and the moveable tab 154 also acts as a locating fixture as well as including a moveable tab for opening the detachable mechanism. The moveable tab 154 can be pressed with finger to open. The bottom portion has but not limited to two mating features 162 and 160 which are features that allow top portion 150 protrusion 158 and moveable tab 154 to slide into locking position, locking textile lure in correct position when detachable mechanism is pressed by hand together. When pressed together onto over-molded 98 Textile lure 142, the lure is securely fixed and cannot be removed until user presses tab 154 in a forward position 162. FIG. 12D is a top view of detachable mechanism 144 in closed position with SECTION A-A Defined. FIG. 12E which is a side view of SECTION A-A of detachable mechanism 144 shown in the closed position. This illustration shows the mating features 162 and 160, protrusion 158, and moveable tab 154 in seated position. Moveable tab 154 clips onto mating feature 160 to lock in closed position. To open detachable mechanism 144, push moveable tab 154 in the direction shown 164.

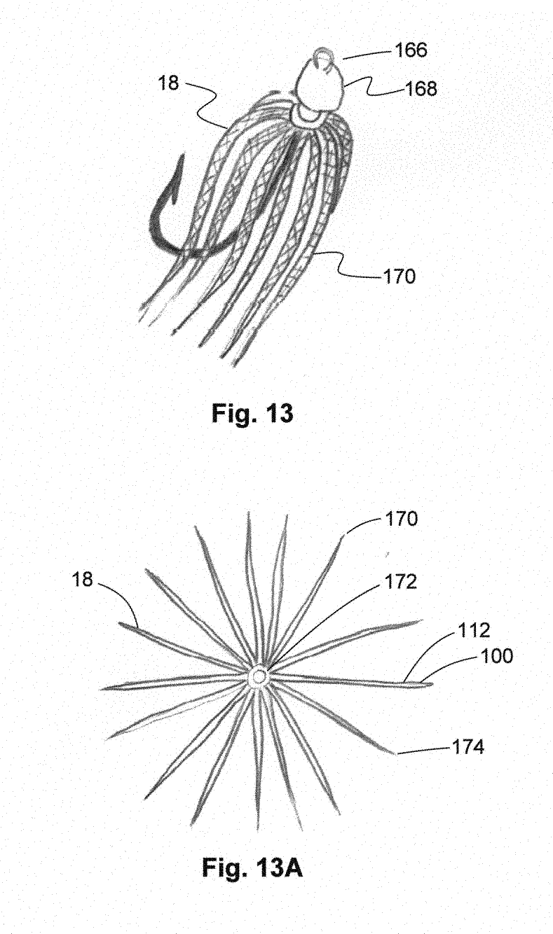

FIG. 13 is an additional application for the textile 18. FIG. 13 is an isometric view of skirted jig lure 166. These types of jigs are a popular lure choice for many fisherman. Generally, they are made of two components, a lead head hook 168, and a skirt 170. The skirts 170 are made of silicone or other elastomers and break apart over short amount time from the teeth of the fish and from being pulled out of fished mouths either after catch or from missing fish after bite or from being pulled thru obstacles in water such as dense weeds, timer, rocks etc. In addition, the skirts color detail is limited base on manufacturing methods of hand pouring, molding, or extruding. The skirts 170 are generally very thin and flexible in the water but because of their thin design and being made of silicone or elastomer they can break easily. In this illustration in FIG. 13, the skirt 170 is made entirely of a textile 18. The benefits to using a textile as a skirt is 1. The textile 18 skirt 170 can be colored in unlimited designs. 2. The textile 18 skirt 170 can be cut in any way desirable strait skirt “tentacles”, wavy, zig zagged etc. and be cut as a single piece as the skirts today are made up of many strands that bind together by a rubber grommet or custom molded rubber ring. 3. The textile 18 skirt 170 is much stronger and will last much longer then silicone or elastomer skirts. FIG. 13A is a top view of an example textile 18 skirt 170 cut pattern. This view shows how the skirts “tentacles” are cut from a single textile 18 sheet 174. A rubber grommet or feature 172 can be over-molded onto the textile 18 skirt 170. These grommets or features are used to secure skirt 170 to hook shank and are commonly used today on skirted jig skirts. The textile 18 skirts 170 may be but not limited to, coated 112 with elastomer or polymer 100 or just textile 18.

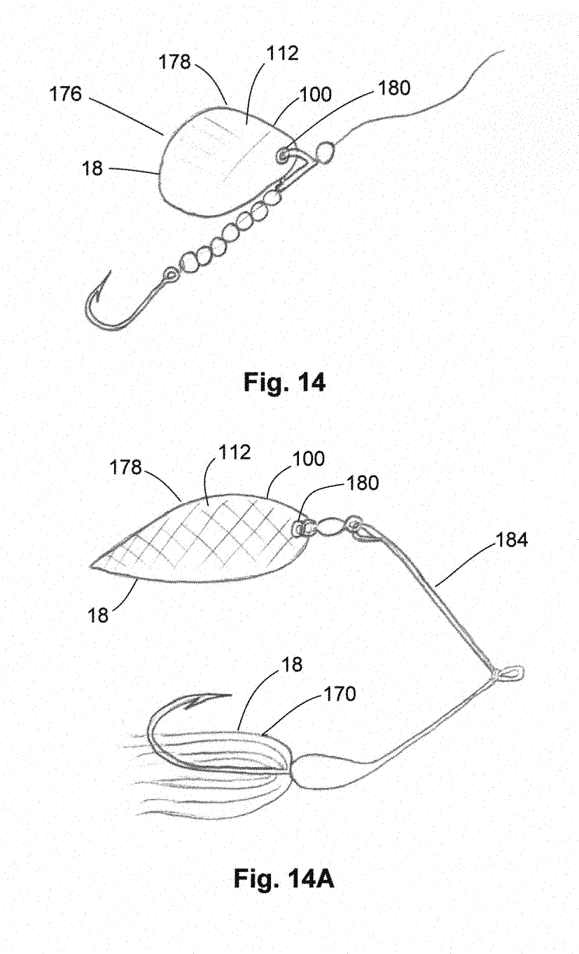

FIG. 14 is another application for the textile 18 used as a fish attracting device. FIG. 14 is a view of a live bait spinner rig 176 which is just one example of many lures today that use spinners as a fish attractant mechanism. Spinner 178 is made entirely out of textile 18 and may or may not be coated 112 with an elastomer or polymer 100. Because of these ease of coloring textiles 18, the color choices are unlimited. Another benefit of a textile 18 spinner is that it would be flexible or soft. Fish are at times quick to spit out a hard object because it does not feel like the naturel prey they feed on and a textile 18 spinner 178 either used by itself or coated 112 with elastomer or polymer 100 would feel like natural prey when in the fish's mouth. The textile 18 spinner 178 can be thermally set with a cup design to give the proven action spinners have today. Also, an eyelet 180 for spinner 178 attachment can be added or riveted onto the textile 18 spinner 178. FIG. 14A is a side view of a spinner bait lure 184 used today and is a very popular lure choice of many fisherman. The spinner bait lure 184 shown includes the textile 18 spinner 178 and is shown as an additional application for the textile 18 spinner 178 and described in FIG. 14. The spinner bait shown also uses a skirt 170 body that would be made of textile 18 as described in FIG. 13 and FIG. 13A.

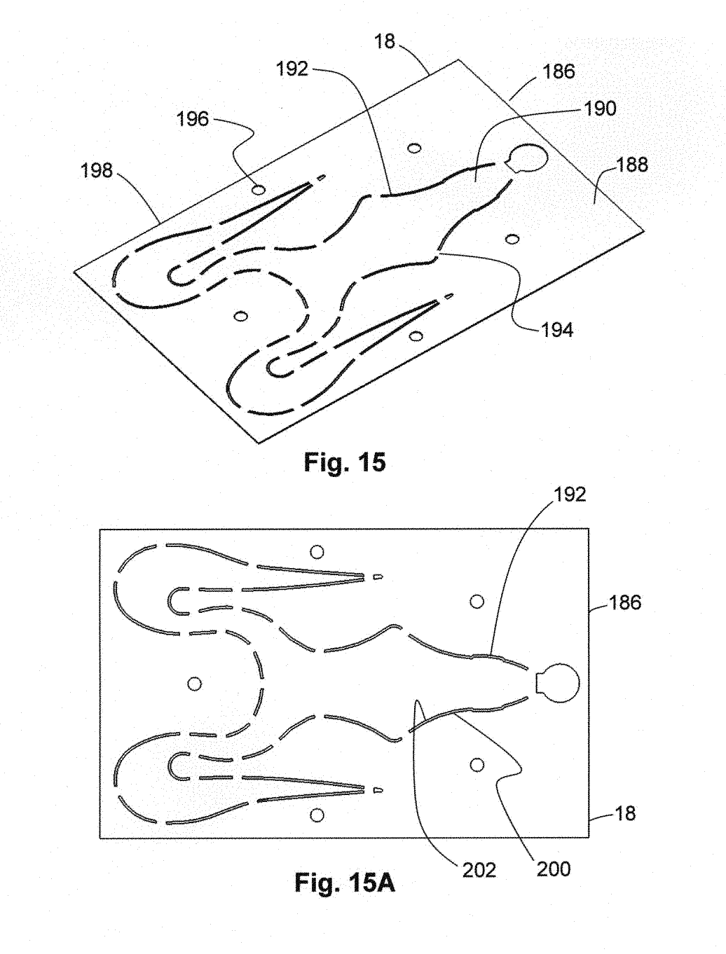

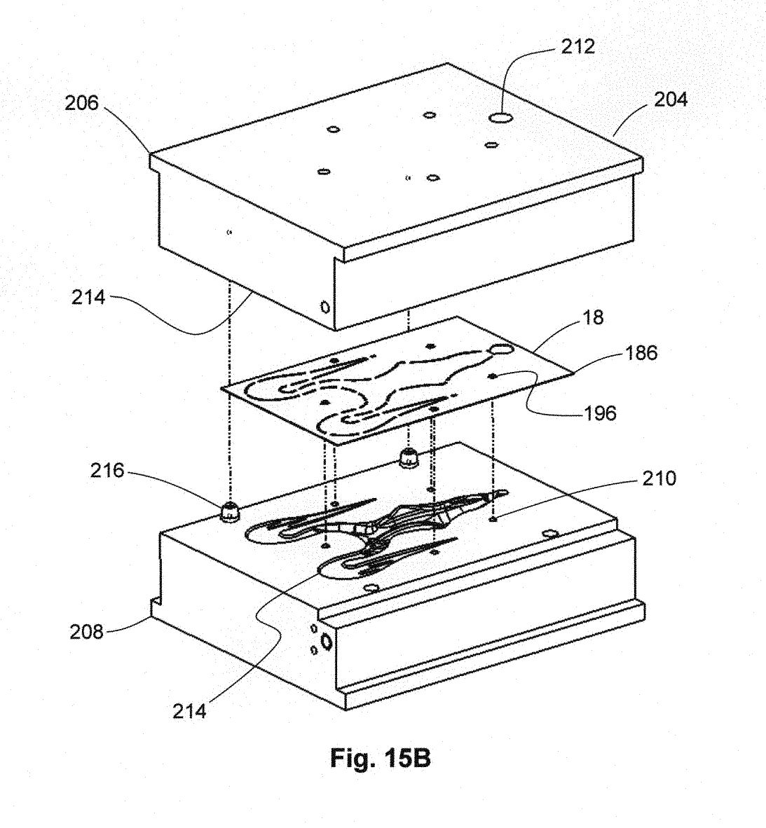

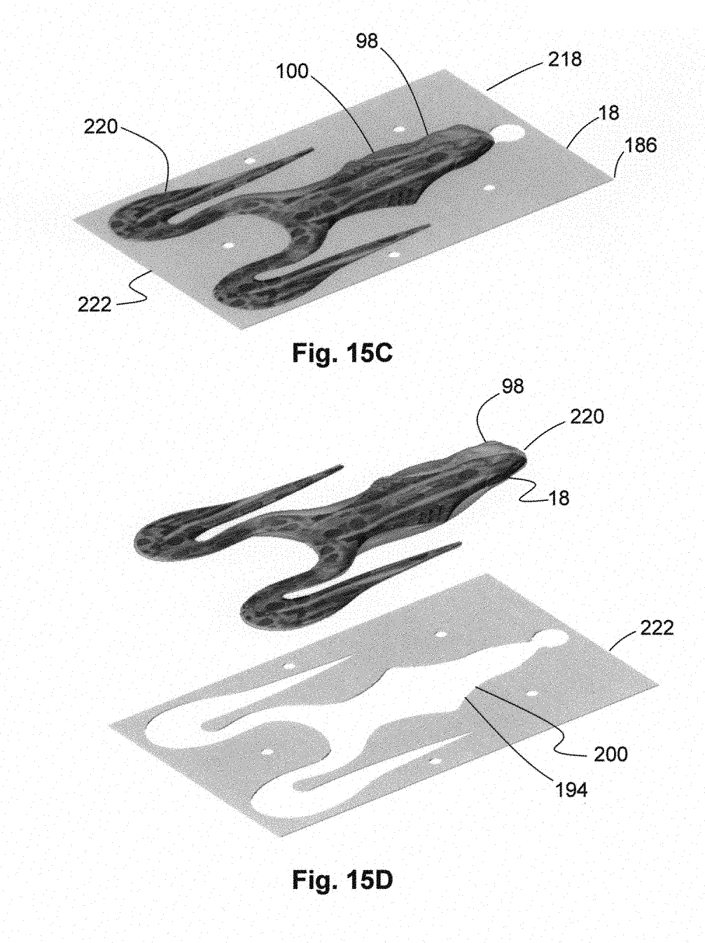

FIG. 15, FIG. 15A, FIG. 15B, FIG. 15C, and FIG. 15D are illustrations based on the manufacturing of the textile lures.

FIG. 15 is an isometric view of a cut textile insert 186 for over-molding applications. The textile 18 is chemically treated with a phosphorous based chemical 188 for bonding of elastomer or polymer to the textile. After chemically treating the textile 18, the textile 18 is colored with single or multiple color region 190 on one or both sides of textile, coloring and designs are unlimited and is not limited to one way of coloration but the preferred method is dye sublimation. Dye sublimation coloring is preferable used as it does not change the bonding properties like other methods of printing or effect the mechanical properties of the textile 18. This invention however is not limited this method. Textile 18 overall size 198 is cut to fit over the mold cavity and the lure detail is cut 192 leaving small tabs 194 to keep textile 18 in place during the molding process. These tabs 194, can be designed to be pulled apart by hand, cut manually, and but not limited to cutting with CO2 laser. After molding process is complete. The cutting of the textile 18, can be done in many ways such as but not limited to hot knife, hot die, CNC die cutter, manual cutting, steel rule dies, or machine dies. But the preferred method is to cut with a CO2 laser. The CO2 laser can be programmed to cut any shape and can match the cavity of the mold perfectly for a very clean mold “shut off”. The CO2 laser also melts the cut fibers of textile 18 together to prevent fraying leaving a very clean cut with even more longevity. Locating holes 196 are also cut in textile 18 prior to molding for easy alignment when placing textile 18 onto mold cavity. (see details below in FIG. 15B for example mold detail). FIG. 15A is a top view of FIG. 15. This view shows greater detail on the cut lure detail 192 on the textile 18 mold insert 186. Outer edge 200 of cut 192 matches the cavity perimeter on both sided of mold and prevents “flash” or molded elastomer or polymer to enter mold parting line. This allows for very clean parts after molding that do not have to be de-flashed. The inner edge 202 of cut-line 192 is recessed into the molded elastomer or polymer. This enhances the cosmetic look and leaves a smooth finish of the over-molded textile 18. FIG. 15B is an isometric view of an example lure mold assembly 204 with textile 18 insert 186. Textile 18 insert 186 locating holes 196 are place over mold bottom side (B side) 208 cavity 214 onto locating pins 210 aligning the textile 18 insert 186 perfectly over cavity 214. Once Textile 18 insert 186 is placed over mold bottom (B side) 208 cavity 214 on locating pins 210, the mold top side (A side) 206 is assembled onto bottom side (B Side) 208 and aligned with dowel pins 216 for cavity 214 alignment. (Cavity 214 is present but not visible in mold top side (A side) 206). Once mold assembly 204 is closed, the mold is clamped together and injected with elastomer or polymer thru gate 212. FIG. 15C is an isometric view on the over-molded 98 textile 18 insert 186, 218. Only the textile 18 lure 220 is over-molded 98 with an elastomer or polymer 100 and the remainder of the textile 18 insert 186 is scrap 222. FIG. 15D is an isometric view of the textile 18 over-molded 98 lure 220 removed from the scrap 222 textile 18 insert 286. The removal process, as described previously in FIG. 15, describes the removal of over-molded 98 textile 18 lure 220 from the scrap 222 textile 18 can be but not limited to small tabs 194 that can be pulled apart by hand at cavity edge 200. The cutting of tabs 194 can be done many other ways such as but not limited to die cutting, hot knife, steel rule die, custom pins in mold on a separate moveable plate, or by manual cutting. After removal of lure 220 from scrap 222 is complete, lure 220 is a finished product.

To fisherman that are aggressive and skilled, this invention offers solutions which they didn't know could be made, but that they have desired on every fishing trip. These lures have been made and tested by the inventors and greatly enhance the durability and the geometrical options that will be offered now.

### Alternative Embodiments

The foregoing description of the exemplary embodiments of the invention has been presented only for the purposes of illustration and description and is not intended to be exhaustive or to limit the invention to the precise forms disclosed. Many modifications and variations are possible in light of the above teaching. The embodiments were chosen and described in order to explain the principles of the invention and their practical application so as to enable others skilled in the art to utilize the invention and various embodiments and with various modifications as are suited to the particular use contemplated. Many alternative embodiments are possible without departing from the spirit and scope of the invention.

We claim:

1. A lifelike fishing lure component apparatus, comprising:
A selectively flexible plane of material constructed from a thin-fiber textile, shaped to accurately resemble a living bait creature.
The textile structurally configured to provide very low deformation in a length axis and a width axis when tensioned while providing high deformation in a vertical axis.
A visual pattern of one or more colors or shades which intensifies the awareness of motion when drawn through or on top of water
At least one location to securely install a fishing hook cooperatively with the textile.

2. The lifelike fishing lure apparatus of claim 1 where the textile is structurally oriented to accept the maximum stress in the longitudinal axis.

3. The apparatus of claim 1 wherein the textile stress tolerance may be profiled using mechanical, chemical and thermal means.

4. The apparatus of claim 1 wherein hook retention force is greater than 5 pounds.

5. The apparatus of claim 1 wherein the textile is printable with infinite variations of color and patterns giving an appearance of living creatures.

6. The apparatus of claim 5 wherein the color and light reflection patterns include patterns which provoke a reaction from fish.

7. The lifelike fishing lure apparatus of claim 1 wherein the textile surface may be modified by mechanical, chemical and thermal means.

8. The apparatus of claim 1 which is over molded with a layer of elastomeric material.

9. The apparatus of claim 8 wherein the layer of elastomeric material forms the three dimensional shape appearance of a living creature.

10. The apparatus of claim 1 wherein the textile shape is infinitely variable and can include width features of 0.2 mm or greater.

11. The apparatus of claim 9 wherein the elastomeric material includes light varying fillers.

12. A fishing lure apparatus comprising:
A fishing lure component comprising of at least one profiled segment of a textile which simulates the features of bait creatures, minimum of one receptor surface location for materials attachment of at least one molecular layer differing from the underlying surface in properties and one or more designated locations for a hook to be retained.

13. The component of claim 12 comprising a method of attachment of the hook wherein the textile is pierced at a single or multiple locations.

14. The component of claim 12 wherein the receptor surface locations is for attachment of polymeric material.

15. The component of claim 12 wherein receptor surface is for the attachment of coloration materials.

16. A method of making a Lifelike Soft Fishing Lure by:
Orienting the textile, shaping a textile material to a planar appearance with features implying a living creature, and preparing at least a single surface for visual effects.

17. The method of claim 16 wherein the shaping is achieved by laser cutting.

18. The method of claim 16 wherein the preparation of surface for visual effect includes the steps of surface preparation for adherence and printing.

19. The method of claim 16 wherein an elastomeric polymer is adherently molded onto a portion or total surface of the textile.

20. The method of claim 16 wherein a semi-rigid or rigid polymer is adherently molded onto a portion or total surface of the textile.
